(19) United States
(12) Patent Application Publication
(10) Pub. No.: US 2010/0112539 A1
(43) Pub. Date: May 6, 2010

(54) SELF-SCORING AND SELF-ANALYZING TEST ANSWER SHEET

(76) Inventors: Howard I. Berrent, Roslyn Heights, NY (US); David A. Steiner, Great Neck, NY (US)

Correspondence Address: KENYON & KENYON LLP, ONE BROADWAY, NEW YORK, NY, 10004, US

(21) Appl. No.: 12/684,716

(22) Filed: Jan. 8, 2010

Related U.S. Application Data
(63) Continuation of application No. 11/196,209, filed on Aug. 2, 2005.
(60) Provisional application No. 60/598,160, filed on Aug. 2, 2004.

(51) Int. Cl. G09B 3/00

(52) U.S. Cl. 434/326; 434/353

(57) ABSTRACT

Self-scoring and self-analyzing test answer sheet which facilitates grading and provides the grader with data concerning the nature of each question and the skill being tested. A skills summary area is provided for recording the total test score and also the number of incorrect responses for each of the specific skills tested.

### BACKGROUND

This invention relates to an improved answer sheet for recording responses to examination test questions. More particularly, this invention relates to a self-scoring and self analyzing test device that indicates the correct answer to the grader and also provides the grader with information concerning the nature of the question asked and the specific skill being tested for each question.

Written examinations have long been used as testing devices. In particular, multiple choice examinations are frequently employed. In correcting multiple choice questions, a grader will frequently rely upon a second document or “answer key” on which the correct answers are marked. This requires the grader to repeatedly look back-and-forth between the student's answer sheet and the answer key and compare the student's answer to the correct response and mark the student's answer sheet to indicate the incorrect responses that the student has recorded. The use of an answer key is physically demanding, requires a significant amount of time, and increases the likelihood that the grader may incorrectly grade the student's paper. In addition, even after the answer sheet has been marked it will usually be devoid of any information related to the nature of the question or the specific subject matter being tested by the specific question, and thus will not identify the particular skill in which the student is deficient.

For the foregoing reasons, there is a need for a self-scoring and self-analyzing answer sheet for recording responses to test questions that can be quickly graded with a minimal of effort while providing valuable information concerning the specific skills in which the person taking the test is having difficulty.

### SUMMARY

The present invention is directed to a self-scoring and self-analyzing answer sheet that can be quickly graded with a minimal of effort while providing valuable information concerning the specific skills in which the person taking the test is having difficulty. The answer sheet comprises a first sheet having a first major surface and a second major surface and lateral edges. The first major surface is provided with a plurality of spaces for recording responses to test questions. A second sheet has a first major surface and a second major surface and lateral edges and the second sheet is of substantially the same shape and size as the first sheet. The second major surface of the first sheet contacts the first major surface of the second sheet and the first major surface of the second sheet is provided with a plurality of spaces for recording responses to test questions corresponding to and in registry with the plurality of spaces for recording responses disposed on the first major surface of the first sheet. The first and second sheets are adapted so that the first major surface of the second sheet cannot be viewed until the first sheet is detached from the second sheet. Means are provided for transferring responses recorded on the plurality of spaces on the first major surface of the first sheet to the corresponding plurality of spaces on the first major surface of the second sheet. The means for transferring are disposed between the first major surface of the first sheet and the second major surface of the second sheet. Correct answer indicia are disposed on the first major surface of the second sheet in localized preselected areas within the plurality of spaces for recording responses to questions. Analytical indicia identifying the skills being tested for each question are disposed on the first major surface of the second sheet in localized preselected areas. Means for attaching and selectively detaching the lateral edges of the second major surface of the first sheet and the lateral edges of the first major surface of the second sheet are provided to prevent viewing of the first major surface of the second sheet until the first sheet has been detached from the second sheet.

### BRIEF DESCRIPTION OF THE DRAWINGS

FIG. 1 shows the first major surface of the first sheet of an answer sheet constructed in accordance with the invention;

FIG. 2 shows the first major surface of the second sheet of an answer sheet constructed in accordance with the invention;

FIG. 3 shows the sheet of FIG. 1 on which responses have been recorded; and

FIG. 4 shows the sheet of FIG. 2 on which the responses shown in FIG. 3 have been transferred.

### DETAILED DESCRIPTION

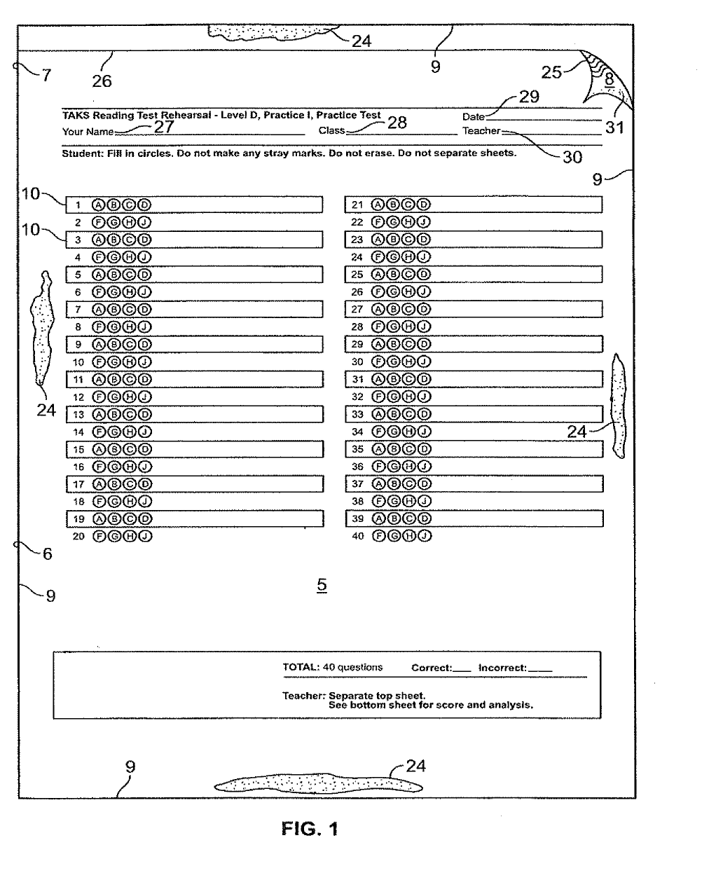

FIG. 1 shows the first major surface 5 of a first sheet 6 of an answer sheet 7 constructed in accordance with the invention. The first sheet 6 has a first major surface 5 and a second major surface 8 and lateral edges 9. A plurality of spaces 10 is provided for recording responses to test questions. In the embodiment shown in FIG. 1 the spaces 10 are formatted for multiple choice-type questions directed to test reading skills; however, it will be appreciated by those skilled in the art that the invention may be used for recording responses to a variety of tests, e.g., math, and may employ a variety of formats for presenting the questions and recording the answers, e.g., “True/False,” “Yes/No,” or short-answer “Fill-In”-type questions.

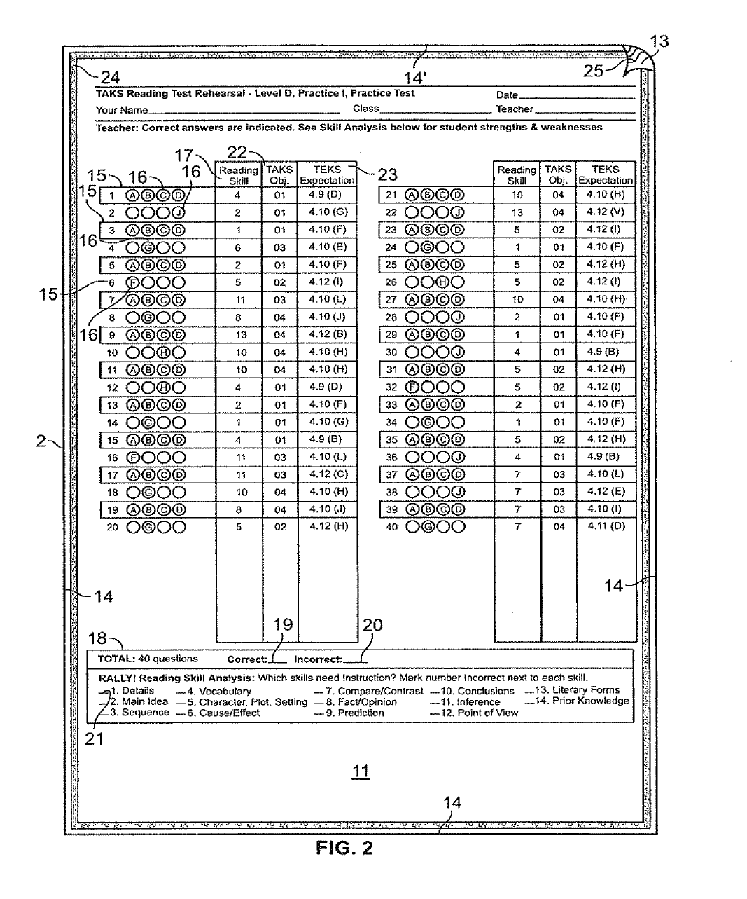

FIG. 2 shows the first major surface 11 of a second sheet 12 of an answer sheet 7 constructed in accordance with the invention. The second sheet 12 has a first major surface 11 and a second major surface 13. The second sheet 12 is substantially the same size as the first sheet 6 and is also provided with lateral edges 14. The first major surface 11 of the second sheet 12 is also provided with a plurality of spaces 15 for recording responses to test questions. These spaces 15 correspond to, and are in registry with, the plurality of spaces 10 for recording answers that are provided on the first major surface 5 of the first sheet 6.

The first major surface 11 of the second sheet 12 is also provided with correct answer indicia 16 indicating what the correct answer for each question is. For example, as shown in FIG. 2, the correct answer to question 1 is “C”; the correct answer to question 2 is “J”; and the correct answer to question 20 is “G”. The use of letters to indicate the correct answer is illustrative of only one embodiment of the invention. It will be appreciated that the correct answer may be indicated in a variety of alternative ways, e.g., by marking an “X” or by “blackening” the correct answer or printing what the correct answer should be such as “True,” “Yes,” or another word, e.g., “Mammals.”

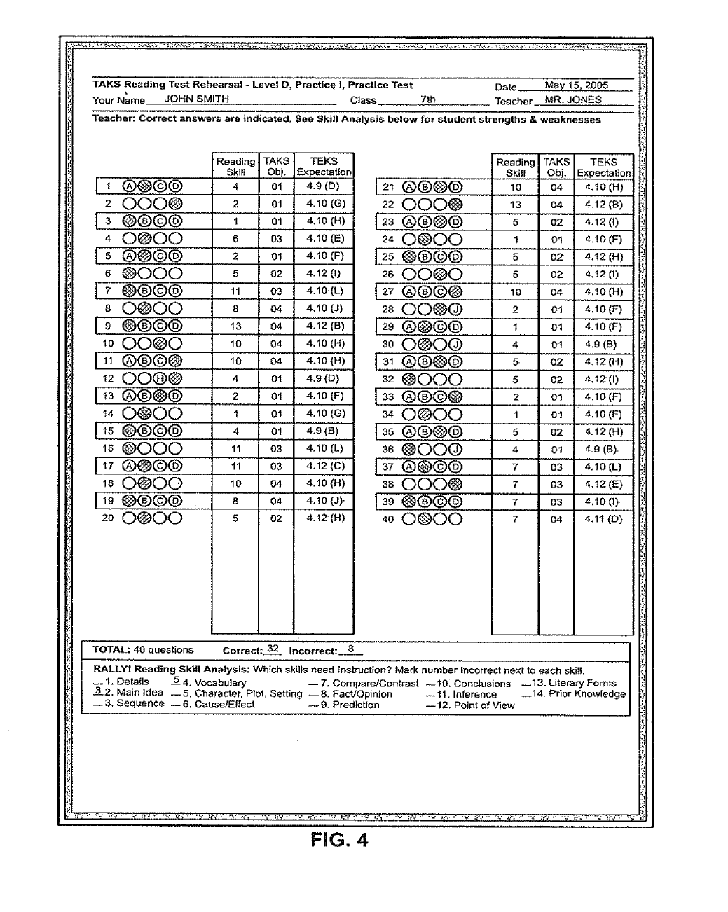

The first major surface 11 of the second sheet 12 is also provided with analytical indicia 17 indicating the nature of the question and the skill or skills being tested. These analytical indicia 17 are disposed in localized preselected areas of the first major surface 11 of the second sheet 12 to enable the person reviewing the second sheet 12 to immediately know the skill or skills to which a particular question pertains. For example, as shown in FIG. 2, the analytical indicia 17 shows that Question 1 tests “Reading Skill 4.” The Skill Analysis area 18 disposed on the first major surface 11 of sheet 12 indicates that Reading Skill 4 is directed to testing “Vocabulary” skills. The Skill Analysis area 18 also provides a section for the grader to record the total number of correct 19 and incorrect 20 responses to the entire test and also the total number of incorrect responses to a particular skill set 21. This provides a convenient summary of overall performance and provides information concerning the specific skills with which the person taking the test is having difficulty. The first major surface 11 of the second sheet 12 may also be provided with other analytical indicia, e.g., 22 and 23 related to the nature of the question and the skills being tested. For example, as shown in FIG. 2 and FIG. 4, the second sheet 12 is provided with a column entitled “TAKS Obj.” 22 which stands for “Texas Assessment of Knowledge and Skill Objective.” FIG. 2 also shows that the second sheet has been provided with a second column entitled “TEKS Expectation” 23 which stands for “Texas Essential Knowledge and Skills Expectations.” Both the TAKS and TEKS are hereby incorporated herein by reference in their entirety. The TAKS and TEKS are published by and available from RALLY! Education, 22 Railroad Avenue, Glen Head, N.Y. 11545. Question 1 is directed to “TAKS Obj. 01.” A review of the TAKS shows that TAKS Objective 01 states: “The student will demonstrate a basic understanding of culturally diverse written texts.” Question 1 is also directed to “TEKS Expectation 4.9 (D).” A review of the TEKS shows that TEKS Expectation 4.9(D) states “The student is expected to determine meanings of derivatives by applying knowledge of the meanings of root words such as like, pay, or happy and affixes such as dis-, pre-, and un-.” (Emphasis in original.) Thus, the second sheet of the graded paper provides valuable analytical information concerning the skill, objectives, and expectations for each question and the specific skills in which the person taking the test is weak. The teacher could then conduct research to locate remedial references that would supply remediation for incorrect responses. Alternatively, the teacher could develop and prepare, specifically tailored remedial materials that are directed to strengthening the skills in which the student is weak. The TAKS and TEKS skills, objectives, and expectations developed by and promulgated by the State of Texas are presented here for illustrative purposes only and it will be appreciated that unique analytical information can be created and customized as specific test applications require, e.g., tests in disciplines, such as math and science for other states and schools and other training institutions at all levels. It will also be appreciated that the answer sheet of this invention can be used in any situation in which a response to an inquiry is desired—even if there is no “right” or “wrong” answer, e.g., an opinion questionnaire, a health questionnaire, or an attitude inventory. In such situations the first major surface of the second sheet can be modified as specific applications dictate, e.g., the correct answer indicia may be modified to show a “preferred” answer or a range of answers, e.g., “most desirable,” “desirable,” and “least desirable;” characteristics associated with mood or personality when the answer sheet is used, e.g., in evaluating a person's mental or emotional state or personality traits or when screening for certain mental or emotional states or characteristics or disorders; or with a scoring system whereby the addition of numbers associated the person's answers to questions may be summed to provide a score on one or more parameters of interest being evaluated. In yet another embodiment, the correct answer indicia may be totally omitted from the second sheet and the analytical indicia may be modified to provide analysis or commentary on the recorded responses.

As shown in FIGS. 1 and 2, means 24 are provided that allow the lateral edges 9 of the second major surface 8 of the first sheet 6 to be selectively attached and detached to and from the lateral edges 14 of the first major surface 11 of the second sheet 12 to prevent the person taking the test from viewing the correct answer indicia 16 or the analytical indicia 17, 22, and 23 disposed on the first major surface 11 of the second sheet 12. The lateral edges 9 of the first sheet 6 and the lateral edges 14 of the second sheet 12 may be attached in a variety of means well known to those skilled in the art as suitable for this purpose, e.g., stapling, taping, crimping, or thermal bonding. In a preferred embodiment, however, an adhesive 24 is utilized. In another preferred embodiment, the first sheet 6 and the second sheet 12 are adapted to minimize the likelihood that a person taking the test could view the first major surface 11 of the second sheet 12 before the first sheet 6 and second sheet 12 are detached. This may be accomplished in a variety of ways well known to those skilled in the art as suitable for this purpose, e.g., by selecting the type, color, and thickness of the paper used to make the first sheet 6 and second sheet 12 to minimize the likelihood that someone could see through them. The second major surface 8 of the first sheet 6 and the second major surface 13 of the second sheet 12 may also be provided with a coating or pattern 25 which makes it difficult to see through the first sheet 6 and the second sheet 12.

In a preferred embodiment a lateral edge 9′ of the first sheet 6 and a lateral edge 14′ of the second sheet 12 are detachably connected, e.g., by scoring the sheets or by providing a line of perforations 26 disposed along at least one lateral edge inwardly of the adhesive 24, as shown in FIGS. 1 and 2. When the lateral edges 9′ of the first sheet 6 and the lateral edge 14′ of the second sheet 12 are detached it provides access to the space between the second major surface 8 of the first sheet 6 and the first major surface 11 of the second sheet 12 and facilitates the detachment of the first sheet 6 from the second sheet 12.

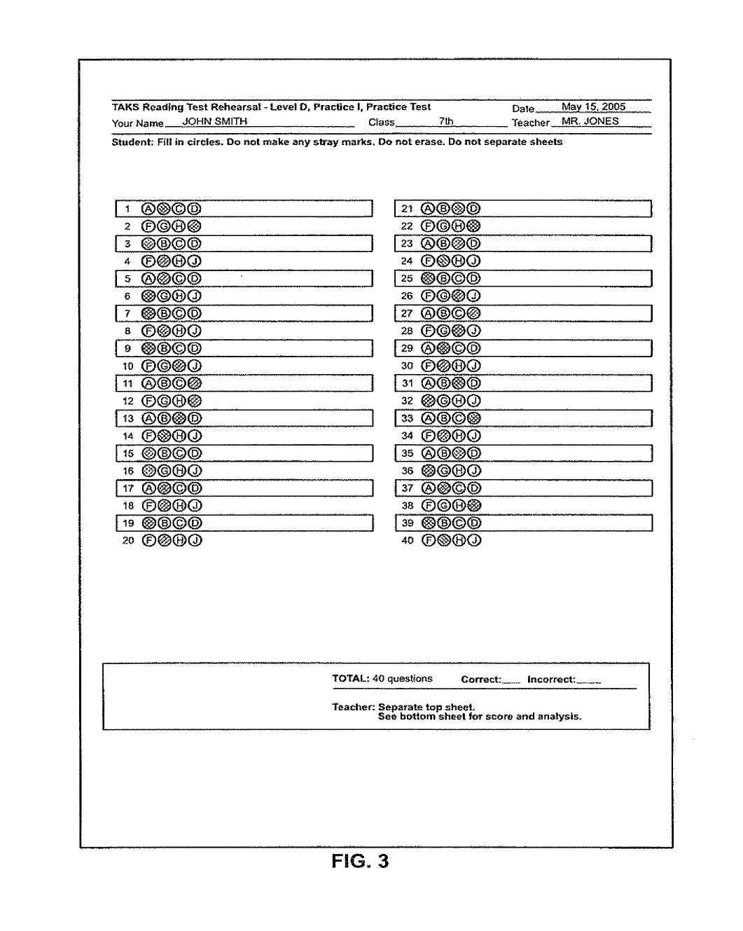

The first major surface 5 of the first sheet 6 may optionally be provided with one or more spaces and indicia for entering identification information, e.g., “Name,” 27, “Class,” 28, “Date,” 29 and “Teacher,” 30 or the name, type, or version of the test, e.g., “TAKS Reading Test Rehearsal-Level D, Practice I, Practice Test” as shown in FIGS. 1 to 4 and all, or some, of this information may optionally be printed on, written on, and or transferred, as specific applications dictate, to the first major surface of the second sheet, as shown in FIGS. 3 and 4.

Means 31 are provided for transferring the responses recorded on the plurality of spaces 10 disposed on the first major surface 5 of the first sheet 6 to the corresponding plurality of spaces 15 disposed on the first major surface 11 of the second sheet 12. A variety of means well known to those skilled in the art as suitable for this purpose may be utilized, e.g., carbon paper or “carbonless” paper is utilized. Carbonless paper is a widely used conventional means for transferring indicia made on one sheet of paper to a sheet or sheets of paper disposed beneath the sheet on which the indicia are made. In one widely used embodiment one or more of the sheets is provided with a coating of millions of microscopic capsules containing colorless dyes and oils that remain sealed until they are broken by the pressure made by applying indicia to the paper. The sheet on which the indicia are to be transferred is provided with a coating of chemicals that react with the released dyes and oils to develop an impression corresponding to the indicia. In another preferred embodiment, millions of pressure dye capsules are embedded in one or more of the sheets. Writing breaks these capsules to create blue or black impressions corresponding to the impressions made when applying the indicia. One source of carbonless paper is NCR Paper® which is available from Appleton, 825 E. Wisconsin, Ave., P.O. Box 359, Appleton, Wis. 54912.

In use, the answer sheet of the present invention is submitted to the individual to be tested, together with a set of test questions, e.g., multiple-choice questions, corresponding in number and identified in a similar manner to the answer spaces on the first major surface of the answer sheet. As the student records his or her answers on the first major surface of the first sheet, their answer is transferred by the means for transferring to the corresponding area of the first major surface of the second sheet. When the examination is completed the proctor collects the test and removes the first sheet from the second sheet. In a preferred embodiment this is done by first folding and then removing a lateral portion of the first and second sheets by tearing along the score line or perforation line. The first sheet can be discarded and the grader can correct the examination paper by comparing the answer entered by the student with the correct answer which is indicated by the correct answer indicia.

After the test has been graded, the grader can enter in the skill analysis summary area the total number of correct and incorrect responses. FIG. 4 shows that for this test there were 32 correct responses which have been recorded in space 19 and 8 incorrect responses which have been recorded in space 20. The grader can also enter in the skill analysis summary area the total number of incorrect responses for each of the skills being tested. For example, as shown in FIG. 4 the person taking this test incorrectly answered Questions 1, 12, 15, 30, and 36 which are intended to test “Reading Skill 4.” Reading skill 4 is directed to “Vocabulary” and because the person taking the test incorrectly answered five questions that tested vocabulary skills, the number “5” has been entered in front of reading skill “4. Vocabulary” in the skill analysis section. FIG. 4 also shows that the person taking this test incorrectly answered Questions 13, 28, and 33 which are intended to test the ability to determine the “Main Idea.” Because the person taking the test incorrectly answered three questions that tested the ability to grasp the main idea skills, the number “3” has been entered in front of reading skill “2. Main Idea” in the skill analysis section. This allows the examination to be quickly and easily graded and provides an answer sheet that is useful both to the student and the teacher because it immediately indicates the specific skills with which the student is having difficulty.

1-25. (canceled)

26. A kit for administering a test, comprising:
a) an examination form comprising a plurality of multiple choice test questions to which responses are required;
b) an answer sheet for recording responses to the multiple choice test questions, the answer sheet comprising:
a first sheet having a first major surface and a second major surface and lateral edges, the first major surface provided with a plurality of spaces for recording responses to the questions;
spaces and indicia disposed on the first major surface of the first sheet for entering identification information;
a second sheet having a first major surface and a second major surface and lateral edges, the second sheet of substantially the same shape and size as the first sheet, the second major surface of the first sheet contacting the first major surface of the second sheet, the first major surface of the second sheet provided with a plurality of spaces for recording responses to the questions corresponding to and in registry with the plurality of spaces for recording responses disposed on the first major surface of the first sheet, wherein the first major surface of the second sheet cannot be viewed until the first sheet is detached from the second sheet;
spaces and indicia disposed on the first major surface of the second sheet for entering identification information;
carbon paper for transferring responses recorded on the plurality of spaces on the first major surface of the first sheet to the corresponding plurality of spaces on the first major surface of the second sheet, the carbon paper disposed between the second major surface of the first sheet and the first major surface of the second sheet;
correct answer indicia disposed on the first major surface of the second sheet in localized preselected areas within the plurality of spaces for recording responses to questions;
analytical indicia for identifying the skills being tested for each question, the indicia disposed on the first major surface of the second sheet adjacent to the plurality of spaces for recording responses to questions;
a skills summary area for recording the total test score and the number of incorrect responses for each of the skills being tested, the skills summary area disposed on the first major surface of the second sheet;
adhesive for attaching the lateral edges of the second major surface of the first sheet and the lateral edges of the first major surface of the second sheet to prevent observation of the first major surface of the second sheet until the first sheet has been detached from the second sheet; and
a line of perforations disposed along at least one lateral edge of the first and second sheets the line of perforations disposed inwardly of the adhesive for detaching the first sheet from the second sheet.
